(19) United States
(12) Patent Application Publication
(10) Pub. No.: US 2026/0329052 A1
(43) Pub. Date: Oct. 22, 2026

(54) PATCH-TYPE ROTATING MIRROR AND RADAR

(71) Applicant: SUTENG INNOVATION TECHNOLOGY CO., LTD., Shenzhen (CN)

(72) Inventors: Xin ZHAO, Shenzhen (CN); Hongbo WANG, Shenzhen (CN); Zhen HE, Shenzhen (CN)

(73) Assignee: SUTENG INNOVATION TECHNOLOGY CO., LTD., Shenzhen (CN)

(21) Appl. No.: 19/646,577

(22) Filed: Apr. 14, 2026

(30) Foreign Application Priority Data
Apr. 16, 2025 (CN) 202510485310.5

(51) Int. Cl. G02B 7/182; G01S 7/481; G02B 7/00; G02B 7/192; H01Q 1/32

(52) U.S. Cl. CPC G02B 7/1821; G01S 7/4813; G01S 7/4817; G02B 7/008; G02B 7/192; H01Q 1/325

(57) ABSTRACT

Embodiments of the present disclosure disclose a patch-type rotating mirror and a radar. The patch-type rotating mirror comprises a mirror lens, a mounting structure, a buffer structure, and a drive assembly. The mirror lens is disposed on the mounting structure. The buffer structure is elastic and is disposed between the mirror lens and the mounting structure; one end of the buffer structure is connected to the mirror lens, and the other end of the buffer structure is connected to the mounting structure. The mounting structure is drivingly connected to the drive assembly; the drive assembly is configured to drive the mounting structure to rotate, and the mirror lens rotates synchronously with the mounting structure.

### CROSS-REFERENCE TO RELATED APPLICATION

The present application claims the benefit of priority to Chinese Patent Application No. 202510485310.5, filed on Apr. 16, 2025, which is hereby incorporated by reference in its entirety.

### TECHNICAL FIELD

Embodiments of the present disclosure relate to the field of radar technology, and in particular, to a patch-type rotating mirror and a radar.

### BACKGROUND

A rotating mirror (a rotary mirror or a scanning mirror) refers to a structure used in a LiDAR to guide laser beams from a laser emitter to the surrounding environment in different directions by rotation or tilting, thereby assisting the LiDAR in spatially scanning a target area, implementing the scanning function of the LiDAR, and acquiring three-dimensional point cloud data. Rotating mirrors generally include glass-integrated rotating mirrors, metal-integrated rotating mirrors, and patch-type rotating mirrors.

A patch-type rotating mirror generally includes a mirror lens and a mounting structure (for example, a mirror frame or a motor housing). Currently, the mirror lens and the mounting structure of a patch-type rotating mirror are generally in direct contact with each other. However, during the use of the patch-type rotating mirror, after the mounting structure receives heat from the motor, the mounting structure undergoes thermal deformation, which tends to cause the mirror lens to be displaced due to the thermal deformation of the mounting structure, resulting in decreased positioning accuracy of the patch-type rotating mirror and decreased measurement accuracy of the LiDAR.

### SUMMARY

Embodiments of the present disclosure aim to provide a patch-type rotating mirror and a radar, capable of improving the positioning accuracy of the patch-type rotating mirror.

To resolve the foregoing technical problem, a technical solution adopted by embodiments of the present disclosure is: providing a patch-type rotating mirror comprising a mirror lens, a mounting structure, a buffer structure, and a drive assembly; the mirror lens is disposed on the mounting structure; the buffer structure is elastic, the buffer structure is disposed between the mirror lens and the mounting structure, one end of the buffer structure is connected to the mirror lens, and the other end of the buffer structure is connected to the mounting structure; and the mounting structure is drivingly connected to the drive assembly, the drive assembly is configured to drive the mounting structure to rotate, and the mirror lens rotates synchronously with the mounting structure.

In some embodiments, the buffer structure comprises a first adhesive assembly, the first adhesive assembly is disposed between the mirror lens and the mounting structure, the first adhesive assembly is elastic, and the first adhesive assembly bonds the mirror lens and the mounting structure to each other and separates the mirror lens and the mounting structure along a first direction.

In some embodiments, the patch-type rotating mirror comprises a second adhesive assembly, the second adhesive assembly is disposed between the mirror lens and the mounting structure, the second adhesive assembly is elastic, and the first adhesive assembly and the second adhesive assembly together bond the mirror lens and the mounting structure to each other and separate the mirror lens and the mounting structure along the first direction.

In some embodiments, a curing rate of the first adhesive assembly is greater than a curing rate of the second adhesive assembly, and the first adhesive assembly is configured to pre-bond the mirror lens to the mounting structure.

In some embodiments, the first adhesive assembly comprises a plurality of first adhesive members and a plurality of second adhesive members, the plurality of first adhesive members and the plurality of second adhesive members are disposed at intervals between the mirror lens and the mounting structure along a second direction, and the first direction is perpendicular to the second direction; and the second adhesive assembly comprises a plurality of third adhesive members, and the plurality of third adhesive members are arranged in an array between the plurality of first adhesive members and the plurality of second adhesive members.

In some embodiments, the mounting structure comprises a rotor housing, a rotor, and a mirror frame; the rotor housing is sleeved on the drive assembly; the rotor is wound around an inner sidewall of the rotor housing; the rotor is drivingly connected to the drive assembly; the drive assembly is configured to drive the rotor to rotate; the mirror frame is sleeved on the rotor housing; the mirror lens is disposed on an outer sidewall of the mirror frame; the buffer structure is disposed between the mirror lens and the mirror frame; the mirror frame is provided with a first limiting hole and a second limiting hole, the first limiting hole and the second limiting hole being disposed at intervals; the rotor housing is provided with a first limiting portion and a second limiting portion; when the mirror frame is sleeved on the rotor housing, the first limiting portion is inserted into the first limiting hole, the second limiting portion is inserted into the second limiting hole, and the first limiting portion and the second limiting portion are configured to restrict relative rotation of the rotor housing and the mirror frame so as to cause the mirror frame to rotate synchronously with the rotor housing.

In some embodiments, the mounting structure comprises a rotor housing and a rotor; the rotor housing is sleeved on the drive assembly; the rotor is wound around an inner sidewall of the rotor housing; the rotor is drivingly connected to the drive assembly; the drive assembly is configured to drive the rotor to rotate; the mirror lens is disposed on an outer sidewall of the rotor housing; the mirror lens rotates with the rotor housing; and the buffer structure is disposed between the mirror lens and the rotor housing.

In some embodiments, the drive assembly comprises a stator base, a stator, a rotating shaft, a bearing, and an elastic member; the stator base is provided with a mounting cavity; the stator is sleeved on the stator base; the bearing is disposed in the mounting cavity; the rotating shaft is inserted into the bearing; the rotating shaft at least partially extends out of the mounting cavity; the elastic member is sleeved on a portion of the rotating shaft extending out of the mounting cavity; the rotor housing is sleeved on the portion of the rotating shaft extending out of the mounting cavity; the elastic member is located between the rotor housing and the bearing; the rotor is wound around an inner sidewall of the rotor housing; and the rotor at least partially surrounds and faces the stator.

In some embodiments, the mirror lens is provided in plurality, the plurality of mirror lenses are arranged circumferentially around a sidewall of the mounting structure, and any two adjacent mirror lenses abut each other.

Another technical solution adopted by embodiments of the present disclosure to resolve the foregoing technical problem is: providing a radar comprising the foregoing patch-type rotating mirror.

The beneficial effects of embodiments of the present disclosure are as follows: in contrast to the prior art, embodiments of the present disclosure provide a patch-type rotating mirror comprising a mirror lens, a mounting structure, a buffer structure, and a drive assembly; the mirror lens is disposed on the mounting structure; the buffer structure is elastic, the buffer structure is disposed between the mirror lens and the mounting structure, one end of the buffer structure is connected to the mirror lens, and the other end of the buffer structure is connected to the mounting structure; the mounting structure is drivingly connected to the drive assembly, the drive assembly is configured to drive the mounting structure to rotate, and the mirror lens rotates synchronously with the mounting structure. By means of the foregoing arrangement, when the mounting structure of embodiments of the present disclosure receives heat generated by the drive assembly during operation and undergoes thermal deformation, the buffer structure is capable of not only accommodating the thermal deformation of the mounting structure through its own elastic deformation, but also absorbing the expansion stress generated during the thermal deformation of the mounting structure, thereby reducing displacement of the mirror lens caused by the thermal deformation of the mounting structure and improving the positioning accuracy of the patch-type rotating mirror.

### BRIEF DESCRIPTION OF DRAWINGS

In order to more clearly illustrate the specific embodiments of the present disclosure or the technical solutions in the prior art, the following briefly describes the drawings. In all drawings, similar elements or parts are generally identified by similar reference numerals. In the drawings, elements or parts are not necessarily drawn to actual scale.

FIG. 1 is a schematic view of the overall structure of a patch-type rotating mirror according to Embodiment I of the present disclosure;

FIG. 2 is a schematic view of a partial structure of a patch-type rotating mirror according to Embodiment I of the present disclosure;

FIG. 3 is an exploded view of the overall structure of a patch-type rotating mirror according to Embodiment I of the present disclosure;

FIG. 4 is a cross-sectional view of the overall structure of a patch-type rotating mirror according to Embodiment I of the present disclosure;

FIG. 5 is a high-temperature surface profile cloud map according to Example 1 of Embodiment I of the present disclosure;

FIG. 6 is a high-temperature surface profile cloud map according to Comparative Example 1 of Embodiment I of the present disclosure;

FIG. 7 is an exploded view of the overall structure of a patch-type rotating mirror according to Embodiment II of the present disclosure; and

FIG. 8 is a cross-sectional view of the overall structure of a patch-type rotating mirror according to Embodiment II of the present disclosure.

Description of reference numerals: 1 mirror lens; 2 mounting structure, 21 rotor housing, 211 first limiting portion, 212 second limiting portion, 22 rotor, 23 mirror frame, 231 first limiting hole, 232 second limiting hole; 3 buffer structure, 31 first adhesive assembly, 311 first adhesive member, 312 second adhesive member, 32 second adhesive assembly, 321 third adhesive member; 4 drive assembly, 43 stator base, 431 mounting cavity, 44 stator, 45 rotating shaft, 46 bearing, 47 elastic member, 49 circuit board; 100 patch-type rotating mirror; 200 patch-type rotating mirror; X first direction, Y second direction.

### DETAILED DESCRIPTION

In order to facilitate understanding of the present disclosure, the following provides a more detailed description of the present disclosure with reference to the accompanying drawings and specific embodiments. It should be noted that when an element is described as being "fixed to" another element, it can be directly on the other element, or there may be one or more intervening elements therebetween. When an element is described as being "connected to" another element, it may be directly connected to the other element, or there may be one or more intervening elements therebetween. The terms "upper," "lower," "inner," "outer," "vertical," "horizontal," and the like as used in this specification indicate orientations or positional relationships based on those shown in the accompanying drawings, and are used merely for convenience of describing the present disclosure and simplifying the description, rather than indicating or implying that the device or element referred to must have a specific orientation, be constructed, and operate in a specific orientation; therefore, these terms should not be construed as limiting the present disclosure. Furthermore, the terms "first," "second," and the like are used for descriptive purposes only and should not be construed as indicating or implying relative importance.

Unless otherwise defined, all technical and scientific terms used in this specification have the same meanings as commonly understood by a person skilled in the technical field to which the present disclosure belongs. The terminology used in the specification of the present disclosure is for the purpose of describing specific embodiments only and is not intended to limit the present disclosure. The term "and/or" as used in this specification includes any and all combinations of one or more of the associated listed items.

### Embodiment I

A rotating mirror (a rotary mirror or a scanning mirror) refers to a structure used in a LiDAR to guide laser beams from a laser emitter to the surrounding environment in different directions by rotation or tilting, thereby assisting the LiDAR in spatially scanning a target area, implementing the scanning function of the LiDAR, and acquiring three-dimensional point cloud data. Rotating mirrors generally include glass-integrated rotating mirrors, metal-integrated rotating mirrors, and patch-type rotating mirrors.

A patch-type rotating mirror generally includes a mirror lens and a mounting structure (for example, a mirror frame or a motor housing). Currently, the mirror lens and the mounting structure of a patch-type rotating mirror are generally in direct contact with each other, i.e., the mirror lens and the mounting structure of the patch-type rotating mirror are in rigid contact, and there is no buffer structure between the mirror lens and the mounting structure of the patch-type rotating mirror. However, during operation of the patch-type rotating mirror, after the mounting structure receives heat from the motor, the mounting structure undergoes thermal deformation, which tends to cause the mirror lens to be displaced due to the thermal deformation of the mounting structure, resulting in decreased positioning accuracy of the patch-type rotating mirror and decreased measurement accuracy of the LiDAR.

Based on the foregoing, the present disclosure provides an embodiment of a patch-type rotating mirror 100, capable of improving the positioning accuracy of the patch-type rotating mirror 100.

In order to facilitate readers' understanding of the inventive concept of embodiments of the present disclosure, the specific structure of the patch-type rotating mirror 100 is described below:

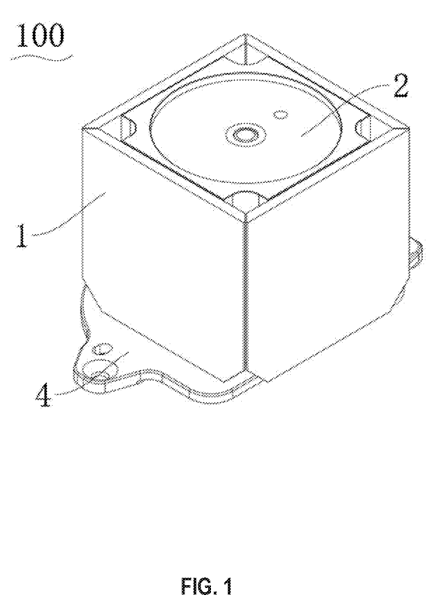

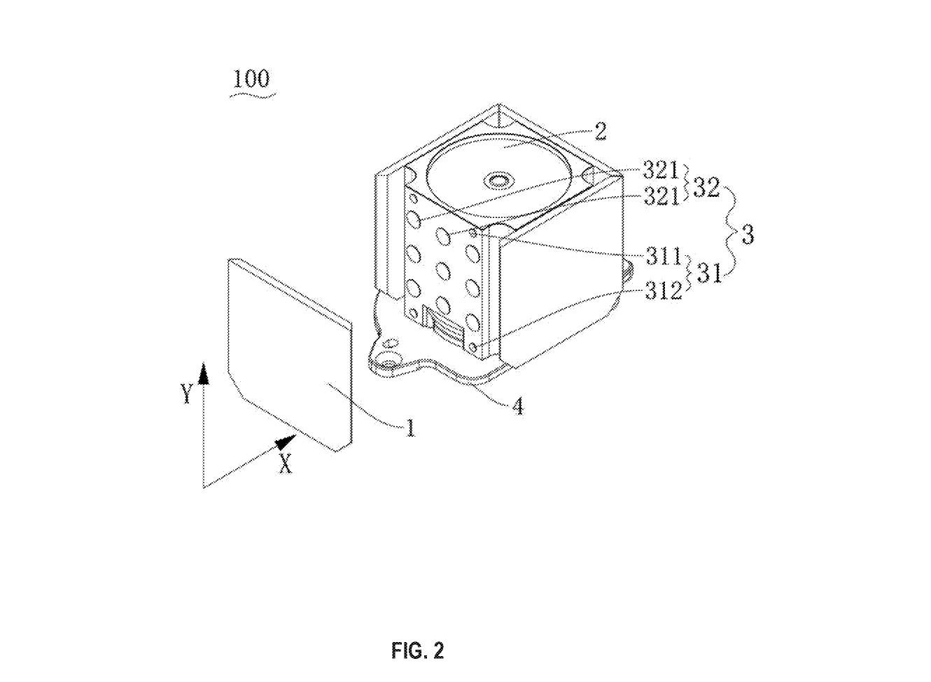

Referring to FIGS. 1 and 2, the patch-type rotating mirror 100 comprises a mirror lens 1, a mounting structure 2, a buffer structure 3, and a drive assembly 4. The mirror lens 1 is disposed on the mounting structure 2. The buffer structure 3 is elastic, and the buffer structure 3 is disposed between the mirror lens 1 and the mounting structure 2; one end of the buffer structure 3 is connected to the mirror lens 1, and the other end of the buffer structure 3 is connected to the mounting structure 2. The mounting structure 2 is drivingly connected to the drive assembly 4, the drive assembly 4 is configured to drive the mounting structure 2 to rotate, and the mirror lens 1 rotates synchronously with the mounting structure 2.

By means of the foregoing arrangement, when the mounting structure 2 receives heat generated by the drive assembly 4 during operation and undergoes thermal deformation, the buffer structure 3 is capable of not only accommodating the thermal deformation of the mounting structure 2 through its own elastic deformation, but also absorbing the expansion stress generated during the thermal deformation of the mounting structure 2, thereby reducing displacement of the mirror lens 1 caused by the thermal deformation of the mounting structure 2 and improving the positioning accuracy of the patch-type rotating mirror 100. In addition, by means of the foregoing arrangement, when the patch-type rotating mirror is applied to a radar, the buffer structure 3 is capable of absorbing vibration generated by the mirror lens 1 and the mounting structure 2 during high-speed rotation, thereby reducing the impact of vibration on the positioning accuracy of the patch-type rotating mirror 100.

Regarding the foregoing buffer structure 3, in some embodiments, referring to FIGS. 1 and 2, the buffer structure 3 comprises a first adhesive assembly 31, the first adhesive assembly 31 is disposed between the mirror lens 1 and the mounting structure 2, the first adhesive assembly 31 is elastic, and the first adhesive assembly 31 bonds the mirror lens 1 and the mounting structure 2 to each other and separates the mirror lens 1 and the mounting structure 2 along the first direction X. By means of the foregoing arrangement, the first adhesive assembly 31 is capable of not only accommodating the thermal deformation of the mounting structure 2 through its own elastic deformation when the mounting structure 2 undergoes thermal deformation, thereby enhancing the buffering effect to reduce displacement of the mirror lens 1 and improve the positioning accuracy of the patch-type rotating mirror 100, but also connecting the mounting structure 2 and the mirror lens 1 to improve the stability of the mounting structure 2 and the mirror lens 1.

Regarding the foregoing buffer structure 3, in some embodiments, referring to FIGS. 1 and 2, the patch-type rotating mirror 100 comprises a second adhesive assembly 32, the second adhesive assembly 32 is disposed between the mirror lens 1 and the mounting structure 2, the second adhesive assembly 32 is elastic, and the first adhesive assembly 31 and the second adhesive assembly 32 together bond the mirror lens 1 and the mounting structure 2 to each other and separate the mirror lens 1 and the mounting structure 2 along the first direction X. By means of the foregoing arrangement, the first adhesive assembly 31 and the second adhesive assembly 32 are capable of not only jointly accommodating the thermal deformation of the mounting structure 2 through their own elastic deformation when the mounting structure 2 undergoes thermal deformation, thereby further enhancing the buffering effect to further reduce displacement of the mirror lens 1 and further improve the positioning accuracy of the patch-type rotating mirror 100, but also jointly connecting the mounting structure 2 and the mirror lens 1 to further improve the stability of the mounting structure 2 and the mirror lens 1. In addition, by means of the foregoing arrangement, the first adhesive assembly 31 and the second adhesive assembly 32 are capable of optimizing the distribution and transmission of mechanical stress between the mounting structure 2 and the mirror lens 1 during operation, reducing mechanical stress concentration caused by a single adhesive point, and thereby reducing the risk of cracking of the mirror lens 1.

Furthermore, in some embodiments, a curing rate of the first adhesive assembly 31 is greater than a curing rate of the second adhesive assembly 32, and the first adhesive assembly 31 is configured to pre-bond the mirror lens 1 to the mounting structure 2. By means of the foregoing arrangement, the first adhesive assembly 31 cures first to pre-fix the mirror lens 1 to the mounting structure 2, and then the second adhesive assembly 32 cures subsequently to finally fix the mirror lens 1 to the mounting structure 2. This step-by-step curing approach is capable of improving the assembly accuracy of the mirror lens 1 and the mounting structure 2 and reducing assembly errors.

Furthermore, in some embodiments, referring to FIGS. 1 and 2, the first adhesive assembly 31 comprises a plurality of first adhesive members 311 and a plurality of second adhesive members 312. The plurality of first adhesive members 311 and the plurality of second adhesive members 312 are disposed at intervals between the mirror lens 1 and the mounting structure 2 along the second direction Y, and the first direction X is perpendicular to the second direction Y; the second adhesive assembly 32 comprises a plurality of third adhesive members 321, and the plurality of third adhesive members 321 are arranged in an array between the plurality of first adhesive members 311 and the plurality of second adhesive members 312. By means of the foregoing arrangement, the first adhesive assembly 31 and the second adhesive assembly 32 are uniformly disposed between the mirror lens 1 and the mounting structure 2, so that the amount of thermal deformation of the mounting structure 2 absorbed by the first adhesive assembly 31 and the second adhesive assembly 32 is substantially equal, thereby improving the uniformity of the thermal deformation absorbed by the first adhesive assembly 31 and the second adhesive assembly 32.

Furthermore, in some embodiments, the plurality of first adhesive members 311 and the plurality of second adhesive members 312 of the first adhesive assembly 31 are all UV-curable adhesives, and the plurality of third adhesive members 321 of the second adhesive assembly 32 are all thermally-cured adhesives.

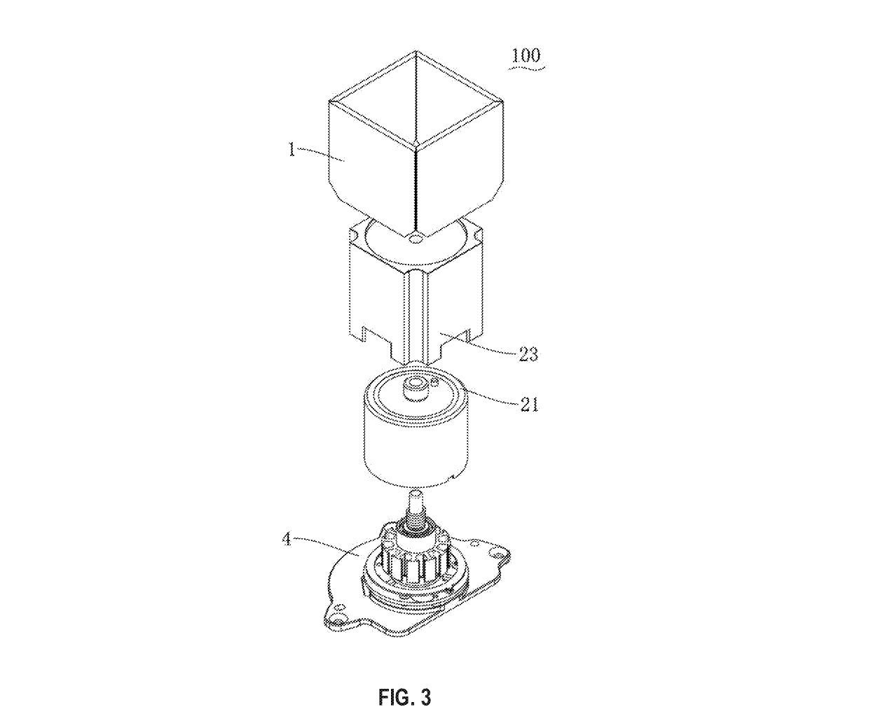

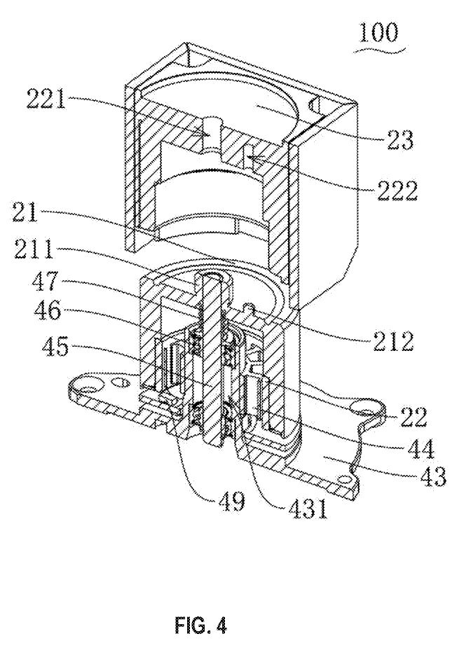

Regarding the foregoing mounting structure, in some embodiments, referring to FIGS. 3 and 4, the mounting structure 2 comprises a rotor housing 21, a rotor 22, and a mirror frame 23. The rotor housing 21 is sleeved on the drive assembly 4. The rotor 22 is wound around an inner sidewall of the rotor housing 21. The rotor 22 is drivingly connected to the drive assembly 4, and the drive assembly 4 is configured to drive the rotor 22 to rotate, so that the rotor housing 21 rotates synchronously with the rotor 22. The mirror frame 23 is sleeved on the rotor housing 21. The mirror lens 1 is disposed on an outer sidewall of the mirror frame 23. The buffer structure 3 is disposed between the mirror lens 1 and the mirror frame 23. The mirror frame 23 is provided with a first limiting hole 231 and a second limiting hole 232, the first limiting hole 231 and the second limiting hole 232 being disposed at intervals. The rotor housing 21 is provided with a first limiting portion 211 and a second limiting portion 212. When the mirror frame 23 is sleeved on the rotor housing 21, the first limiting portion 211 is inserted into the first limiting hole 231, the second limiting portion 212 is inserted into the second limiting hole 232, and the first limiting portion 211 and the second limiting portion 212 are configured to restrict relative rotation of the rotor housing 21 and the mirror frame 23 so as to cause the mirror frame 23 to rotate synchronously with the rotor housing 21. By means of the foregoing arrangement, the mirror lens 1 is directly connected to the mirror frame 23 and is indirectly connected to the rotor housing 21, which facilitates individually adjusting the position and angle of the mirror lens 1 through the mirror frame 23, thereby helping to meet maintenance, replacement, and testing requirements of the mirror lens 1.

Furthermore, in some embodiments, referring to FIG. 4, the drive assembly 4 comprises a stator base 43, a stator 44, a rotating shaft 45, a bearing 46, and an elastic member 47. The stator base 43 is provided with a mounting cavity 431. The stator 44 is sleeved on the stator base 43. The bearing 46 is disposed in the mounting cavity 431. The rotating shaft 45 is inserted into the bearing 46. The rotating shaft 45 at least partially extends out of the mounting cavity 431. The elastic member 47 is sleeved on a portion of the rotating shaft 45 extending out of the mounting cavity 431. The rotor housing 21 is sleeved on the portion of the rotating shaft 45 extending out of the mounting cavity 431. The elastic member 47 is located between the rotor housing 21 and the bearing 46. The rotor 22 is wound around an inner sidewall of the rotor housing 21. The rotor 22 at least partially surrounds and faces the stator 44. To facilitate readers' understanding of the operation of the drive assembly 4, the following provides an example: first, the stator 44 generates a rotating magnetic field when energized; then, the rotor 22 is driven to rotate under the action of the rotating magnetic field; subsequently, the rotor housing 21 rotates synchronously with the rotor 22; during this process, the rotating shaft 45 rotates with the rotor housing 21 and supports the rotor housing 21; finally, the mirror frame 23 and the mirror lens 1 rotate synchronously with the rotor housing 21. By means of the foregoing arrangement, during the driving process of the drive assembly 4, the bearing 46 is capable of improving the rotational stability of the rotating shaft 45, reducing rotational errors of the rotating shaft 45 caused by friction, and reducing the impact of rotational errors on the positioning accuracy of the patch-type rotating mirror 100. In addition, the elastic member 47 is capable of absorbing vibration generated by the rotor housing 21, the rotating shaft 45, and the rotor 22 during rotation, thereby reducing the impact of vibration on the positioning accuracy of the patch-type rotating mirror 100.

Regarding the foregoing drive assembly 4, in some embodiments, referring to FIG. 4, the drive assembly 4 comprises a circuit board 49, the circuit board 49 is sleeved on the stator base 43, the circuit board 49 is positioned below the stator 44, and the circuit board 49 is electrically connected to the stator 44. By means of the foregoing arrangement, the circuit board 49 is integrated into the drive assembly 4, which is capable of reducing the connecting structures and connecting cables required for external placement of the circuit board 49 and helps improve the structural compactness of the drive assembly 4.

Regarding the foregoing patch-type rotating mirror 100, referring to FIGS. 1 and 2, the mirror lens 1 is provided in plurality, the plurality of mirror lenses 1 are arranged circumferentially around a sidewall of the mounting structure 2, and any two adjacent mirror lenses 1 abut each other. By means of the foregoing arrangement, the circumferential arrangement of the plurality of mirror lenses 1 is capable of expanding the scanning angle of the patch-type rotating mirror 100, so that the patch-type rotating mirror 100 achieves a wider scanning angle and, when applied to a radar, improves the scanning range of the radar. In addition, by means of the foregoing arrangement, the mutual abutment of any two adjacent mirror lenses 1 is capable of not only avoiding light deviation caused by gaps between any two adjacent mirror lenses 1 to improve the reflective accuracy of the patch-type rotating mirror 100 in reflecting laser beams, but also enabling any two adjacent mirror lenses 1 to mutually support each other, thereby improving the stability of the overall structure of the patch-type rotating mirror 100.

Embodiments of the present disclosure provide a patch-type rotating mirror 100 comprising a mirror lens 1, a mounting structure 2, a buffer structure 3, and a drive assembly 4. The mirror lens 1 is disposed on the mounting structure 2. The buffer structure 3 is elastic, the buffer structure 3 is disposed between the mirror lens 1 and the mounting structure 2, one end of the buffer structure 3 is connected to the mirror lens 1, and the other end of the buffer structure 3 is connected to the mounting structure 2. The mounting structure 2 is drivingly connected to the drive assembly 4, the drive assembly 4 is configured to drive the mounting structure 2 to rotate, and the mirror lens 1 rotates synchronously with the mounting structure 2. By means of the foregoing arrangement, when the mounting structure 2 of embodiments of the present disclosure receives heat generated by the drive assembly 4 during operation and undergoes thermal deformation, the buffer structure 3 is capable of not only accommodating the thermal deformation of the mounting structure 2 through its own elastic deformation, but also absorbing the expansion stress generated during the thermal deformation of the mounting structure 2, thereby reducing displacement of the mirror lens 1 caused by the thermal deformation of the mounting structure 2 and improving the positioning accuracy of the patch-type rotating mirror 100.

In order to verify the inventive concept of the patch-type rotating mirror 100 of the present disclosure, the following describes a thermal deformation test performed on the patch-type rotating mirror 100 of embodiments of the present disclosure:

First, Example 1 having the same structure as the patch-type rotating mirror 100 of embodiments of the present disclosure is set up. Example 1 comprises a mirror lens, a mirror frame, and a buffer structure. The buffer structure comprises a plurality of UV-curable adhesives and a plurality of thermally-cured adhesives. The plurality of UV-curable adhesives and the plurality of thermally-cured adhesives are regularly disposed between the mirror lens and the mirror frame. The plurality of UV-curable adhesives and the plurality of thermally-cured adhesives bond the mirror lens to the mirror frame, and the mirror lens and the mirror frame are separated from each other.

Then, Comparative Example 1 is set up. Comparative Example 1 comprises a mirror lens, a mirror frame, and an adhesive structure. The adhesive structure comprises a plurality of UV-curable adhesives and a plurality of thermally-cured adhesives. The surface of the mirror frame used for bonding the mirror lens is regularly provided with a plurality of UV-curable adhesive grooves and a plurality of thermally-cured adhesive grooves; one UV-curable adhesive is disposed in one UV-curable adhesive groove, and one thermally-cured adhesive is disposed in one thermally-cured adhesive groove. The plurality of UV-curable adhesives and the plurality of thermally-cured adhesives bond the mirror lens to the mirror frame, and the mirror lens and the mirror frame are in rigid contact with each other.

Finally, a thermal deformation test is performed as follows: first, Example 1 and Comparative Example 1 are placed in an environment with a controllable temperature (for example, a constant-temperature oven or a constant-temperature hot stage), and the temperature is gradually increased to a preset temperature (for example, 80 °C, 100 °C, or higher); second, a laser profilometer, a white-light interferometer, or an autocollimator is used to separately detect the deformation of the mirror lens of Example 1 and the deformation of the mirror lens of Comparative Example 1, and the PV value is calculated from the surface profile measurement data to generate corresponding high-temperature surface profile cloud maps.

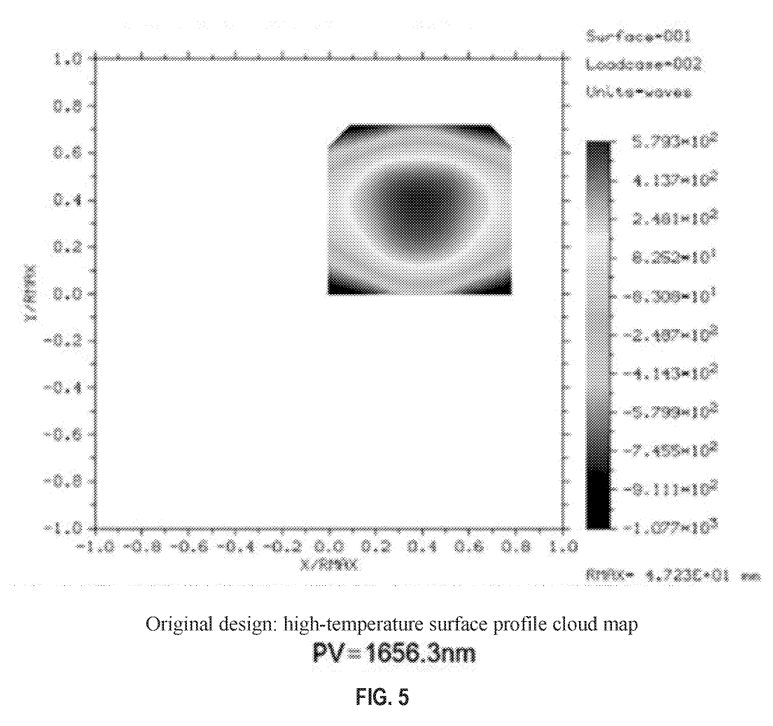

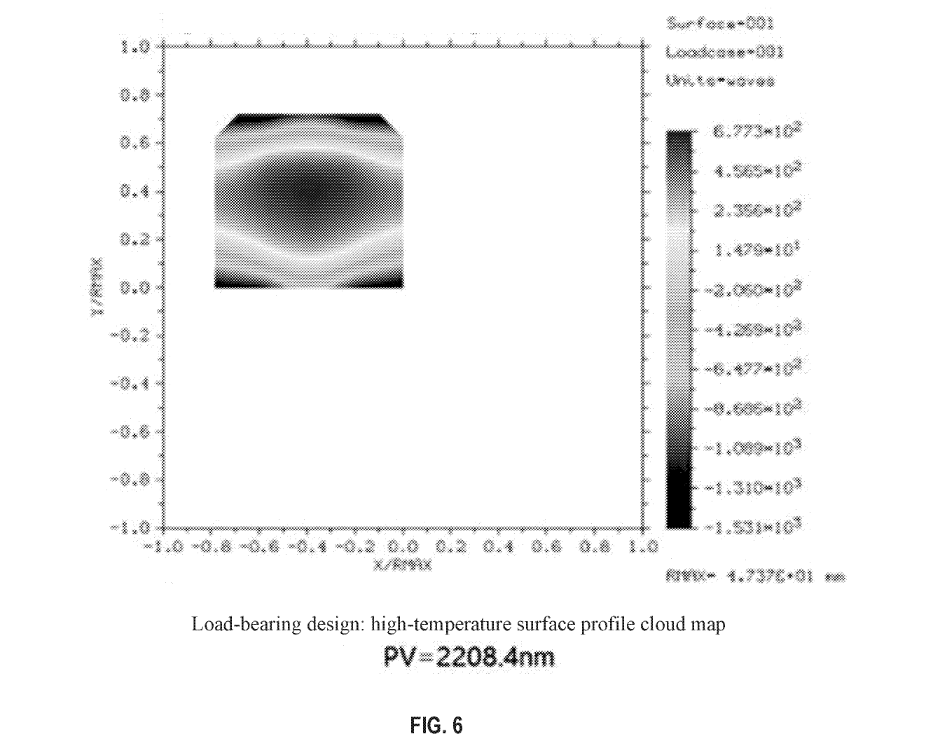

Referring to FIGS. 5 and 6, FIG. 5 shows the PV value and the high-temperature surface profile cloud map of Example 1, and FIG. 6 shows the PV value and the high-temperature surface profile cloud map of Comparative Example 1. The PV value of Example 1 is less than the PV value of Comparative Example 1, i.e., the degree of deformation of the mirror lens of Example 1 is less than the degree of deformation of the mirror lens of Comparative Example 1. This demonstrates that the buffer structure of Example 1 is capable of effectively absorbing the thermal deformation of the mirror frame, reducing mirror lens deformation caused by the thermal deformation of the mirror frame, i.e., reducing displacement of the mirror lens due to the thermal deformation of the mirror frame, and helps improve the positioning accuracy of the patch-type rotating mirror 100.

### Embodiment II

Currently, in a patch-type rotating mirror, the surface-axis included angle (pitch angle) between the mirror surface and the motor shaft is related to the consistency of point clouds between different frames. The surface-axis included angle (pitch angle) between the mirror surface and the motor shaft typically comprises the patch-type rotating mirror pitch angle formed by the fit between the mounting surfaces of the mirror lens and the mirror frame, the assembly pitch angle formed by the fit between the mounting surfaces of the mirror frame and the motor housing, and the motor pitch angle formed after assembly of the internal components and shaft system of the motor, which tends to result in an excessively large total pitch angle of the patch-type rotating mirror and poor consistency of point clouds between different frames.

Based on the foregoing, the present disclosure provides another embodiment of a patch-type rotating mirror 200, capable of reducing the total pitch angle of the patch-type rotating mirror 200.

In order to facilitate readers' understanding of the inventive concept of Embodiment II of the present disclosure, the specific structure of the patch-type rotating mirror 200 is described below. Embodiment II of the patch-type rotating mirror 200 is based on Embodiment I of the patch-type rotating mirror 100 with a modification to the structure of the mounting structure 2. Therefore, the difference between the patch-type rotating mirror 100 of Embodiment I and the patch-type rotating mirror 200 of Embodiment II lies in the difference in the mounting structure 2:

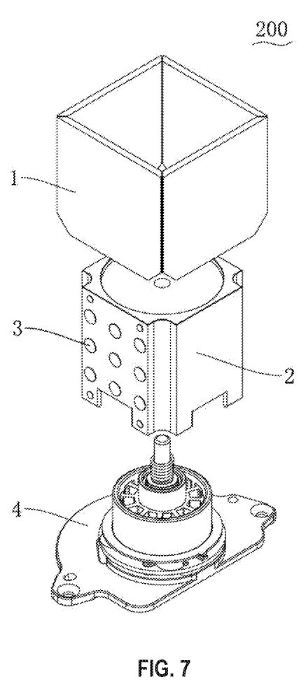

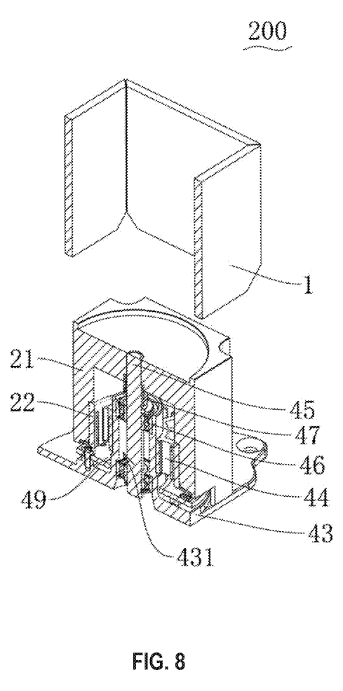

Referring to FIGS. 7 and 8, the patch-type rotating mirror 200 comprises a mirror lens 1, a mounting structure 2, a buffer structure 3, and a drive assembly 4. The mirror lens 1 is disposed on the mounting structure 2. The buffer structure 3 is elastic, and the buffer structure 3 is disposed between the mirror lens 1 and the mounting structure 2; one end of the buffer structure 3 is connected to the mirror lens 1, and the other end of the buffer structure 3 is connected to the mounting structure 2. The mounting structure 2 is drivingly connected to the drive assembly 4, the drive assembly 4 is configured to drive the mounting structure 2 to rotate, and the mirror lens 1 rotates synchronously with the mounting structure 2.

By means of the foregoing arrangement, when the mounting structure 2 receives heat generated by the drive assembly 4 during operation and undergoes thermal deformation, the buffer structure 3 is capable of not only accommodating the thermal deformation of the mounting structure 2 through its own elastic deformation, but also absorbing the expansion stress generated during the thermal deformation of the mounting structure 2, thereby reducing displacement of the mirror lens 1 caused by the thermal deformation of the mounting structure 2 and improving the positioning accuracy of the patch-type rotating mirror 200. In addition, by means of the foregoing arrangement, when the patch-type rotating mirror are applied to a radar, the buffer structure 3 is capable of absorbing vibration generated by the mirror lens 1 and the mounting structure 2 during high-speed rotation, thereby reducing the impact of vibration on the positioning accuracy of the patch-type rotating mirror 200.

Regarding the foregoing mounting structure 2, in some embodiments, referring to FIGS. 7 and 8, the mounting structure 2 comprises a rotor housing 21 and a rotor 22. The rotor housing 21 is sleeved on the drive assembly 4. The rotor 22 is wound around an inner sidewall of the rotor housing 21. The rotor 22 is drivingly connected to the drive assembly 4, and the drive assembly 4 is configured to drive the rotor 22 to rotate, so that the rotor housing 21 rotates synchronously with the rotor 22. The mirror lens 1 is disposed on an outer sidewall of the rotor housing 21. The mirror lens 1 rotates with the rotor housing 21. The buffer structure 3 is disposed between the mirror lens 1 and the rotor housing 21. By means of the foregoing arrangement, the mirror lens 1 is directly connected to the rotor housing 21, the mirror frame 23 is omitted, and thereby the assembly pitch angle formed by the fit between the mounting surfaces of the mirror frame 23 and the rotor housing 21 is eliminated. Only the patch-type rotating mirror pitch angle and the motor pitch angle remain, thus reducing the total pitch angle of the patch-type rotating mirror, improving consistency of point clouds between different frames, reducing point cloud jitter, and improving point cloud quality. In addition, by means of the foregoing arrangement, the mirror lens 1 is directly connected to the rotor housing 21 and the mirror frame 23 is omitted, which reduces the number of components, simplifies the structure, and lowers costs. Meanwhile, by means of the foregoing arrangement, under the same optical dimension constraints, since the mirror frame 23 is omitted, the outer diameter of the rotor housing 21 can be increased, which is equivalent to an increase in the outer diameter of the motor, enabling the electromagnetic design inside the motor to accommodate a larger load and improving the torque safety margin.

Furthermore, in some embodiments, referring to FIGS. 7 and 8, the drive assembly 4 comprises a stator base 43, a stator 44, a rotating shaft 45, a bearing 46, and an elastic member 47. The stator base 43 is provided with a mounting cavity 431. The stator 44 is sleeved on the stator base 43. The bearing 46 is disposed in the mounting cavity 431. The rotating shaft 45 is inserted into the bearing 46. The rotating shaft 45 at least partially extends out of the mounting cavity 431. The elastic member 47 is sleeved on a portion of the rotating shaft 45 extending out of the mounting cavity 431. The rotor housing 21 is sleeved on the portion of the rotating shaft 45 extending out of the mounting cavity 431. The elastic member 47 is located between the rotor housing 21 and the bearing 46. The rotor 22 is wound around an inner sidewall of the rotor housing 21. The rotor 22 at least partially surrounds and faces the stator 44. To facilitate understanding of the operation of the drive assembly 4, the following provides an example: first, the stator 44 generates a rotating magnetic field when energized; then, the rotor 22 is driven to rotate under the action of the rotating magnetic field; subsequently, the rotor housing 21 rotates synchronously with the rotor 22; during this process, the rotating shaft 45 rotates with the rotor housing 21 and supports the rotor housing 21; finally, the mirror lens 1 rotates synchronously with the rotor housing 21. By means of the foregoing arrangement, during the driving process of the drive assembly 4, the bearing 46 is capable of improving the rotational stability of the rotating shaft 45, reducing rotational errors of the rotating shaft 45 caused by friction, and reducing the impact of rotational errors on the positioning accuracy of the patch-type rotating mirror 200. In addition, the elastic member 47 is capable of absorbing vibration generated by the rotor housing 21, the rotating shaft 45, and the rotor 22 during rotation, thereby reducing the impact of vibration on the positioning accuracy of the patch-type rotating mirror 200.

Regarding the foregoing drive assembly 4, in some embodiments, referring to FIGS. 7 and 8, the drive assembly 4 comprises a circuit board 49, the circuit board 49 is sleeved on the stator base 43, the circuit board 49 is positioned below the stator 44, and the circuit board 49 is electrically connected to the stator 44. By means of the foregoing arrangement, the circuit board 49 is integrated into the drive assembly 4, which is capable of reducing the connecting structures and connecting cables required for external placement of the circuit board 49 and helps improve the structural compactness of the drive assembly 4.

Regarding the foregoing patch-type rotating mirror 200, referring to FIGS. 7 and 8, the mirror lens 1 is provided in plurality. The plurality of mirror lenses 1 are arranged circumferentially around a sidewall of the mounting structure 2, and any two adjacent mirror lenses 1 abut each other. By means of the foregoing arrangement, the circumferential arrangement of the plurality of mirror lenses 1 is capable of expanding the scanning angle of the patch-type rotating mirror 200, so that the patch-type rotating mirror 200 achieves a wider scanning angle and, when applied to a radar, improves the scanning range of the radar. In addition, by means of the foregoing arrangement, the mutual abutment of any two adjacent mirror lenses 1 is capable of not only avoiding light deviation caused by gaps between any two adjacent mirror lenses 1 to improve the reflective accuracy of the patch-type rotating mirror 200 in reflecting laser beams, but also enabling any two adjacent mirror lenses 1 to mutually support each other, thereby improving the stability of the overall structure of the patch-type rotating mirror 200.

The present disclosure further provides an embodiment of a radar, wherein the radar comprises the foregoing patch-type rotating mirror 100 and/or the foregoing patch-type rotating mirror 200. For the specific structures and functions of the foregoing patch-type rotating mirror 100 and/or the foregoing patch-type rotating mirror 200, reference may be made to the foregoing Embodiment I and Embodiment II, which will not be repeated here.

The foregoing descriptions are merely embodiments of the present disclosure and are not intended to limit the patent scope of the present disclosure. Any equivalent structural or equivalent process transformations made using the content of the specification and drawings of the present disclosure, or any direct or indirect application in other related technical fields, are likewise included within the patent protection scope of the present disclosure.

What is claimed is:

1. A patch-type rotating mirror, comprising: a mirror lens; a mounting structure, wherein the mirror lens is disposed on the mounting structure; a buffer structure, wherein the buffer structure is elastic, the buffer structure is disposed between the mirror lens and the mounting structure, one end of the buffer structure is connected to the mirror lens, and the other end of the buffer structure is connected to the mounting structure; and a drive assembly, wherein the mounting structure is drivingly connected to the drive assembly, the drive assembly is configured to drive the mounting structure to rotate, and the mirror lens rotates synchronously with the mounting structure.

2. The patch-type rotating mirror according to claim 1, wherein the buffer structure comprises a first adhesive assembly, wherein the first adhesive assembly is disposed between the mirror lens and the mounting structure, the first adhesive assembly is elastic, and the first adhesive assembly bonds the mirror lens and the mounting structure to each other and separates the mirror lens and the mounting structure along a first direction.

3. The patch-type rotating mirror according to claim 2, wherein the patch-type rotating mirror comprises a second adhesive assembly, wherein the second adhesive assembly is disposed between the mirror lens and the mounting structure, the second adhesive assembly is elastic, and the first adhesive assembly and the second adhesive assembly together bond the mirror lens and the mounting structure to each other and separate the mirror lens and the mounting structure along the first direction.

4. The patch-type rotating mirror according to claim 3, wherein a curing rate of the first adhesive assembly is greater than a curing rate of the second adhesive assembly, and the first adhesive assembly is configured to pre-bond the mirror lens to the mounting structure.

5. The patch-type rotating mirror according to claim 3, wherein: the first adhesive assembly comprises a plurality of first adhesive members and a plurality of second adhesive members, the plurality of first adhesive members and the plurality of second adhesive members are disposed at intervals between the mirror lens and the mounting structure along a second direction, and the first direction is perpendicular to the second direction; and the second adhesive assembly comprises a plurality of third adhesive members, and the plurality of third adhesive members are arranged in an array between the plurality of first adhesive members and the plurality of second adhesive members.

6. The patch-type rotating mirror according to claim 1, wherein the mounting structure comprises a rotor housing, a rotor, and a mirror frame; the rotor housing is sleeved on the drive assembly; the rotor is wound around an inner sidewall of the rotor housing; the rotor is drivingly connected to the drive assembly; the drive assembly is configured to drive the rotor to rotate; the mirror frame is sleeved on the rotor housing; the mirror lens is disposed on an outer sidewall of the mirror frame; the buffer structure is disposed between the mirror lens and the mirror frame; the mirror frame is provided with a first limiting hole and a second limiting hole, the first limiting hole and the second limiting hole being disposed at intervals; the rotor housing is provided with a first limiting portion and a second limiting portion; and when the mirror frame is sleeved on the rotor housing, the first limiting portion is inserted into the first limiting hole, the second limiting portion is inserted into the second limiting hole, and the first limiting portion and the second limiting portion are configured to restrict relative rotation of the rotor housing and the mirror frame so as to cause the mirror frame to rotate synchronously with the rotor housing.

7. The patch-type rotating mirror according to claim 1, wherein the mounting structure comprises a rotor housing and a rotor; the rotor housing is sleeved on the drive assembly; the rotor is wound around an inner sidewall of the rotor housing; the rotor is drivingly connected to the drive assembly; the drive assembly is configured to drive the rotor to rotate; the mirror lens is disposed on an outer sidewall of the rotor housing; the mirror lens rotates with the rotor housing; and the buffer structure is disposed between the mirror lens and the rotor housing.

8. The patch-type rotating mirror according to claim 6, wherein the drive assembly comprises a stator base, a stator, a rotating shaft, a bearing, and an elastic member; the stator base is provided with a mounting cavity; the stator is sleeved on the stator base; the bearing is disposed in the mounting cavity; the rotating shaft is inserted into the bearing; the rotating shaft at least partially extends out of the mounting cavity; the elastic member is sleeved on a portion of the rotating shaft extending out of the mounting cavity; the rotor housing is sleeved on the portion of the rotating shaft extending out of the mounting cavity; the elastic member is located between the rotor housing and the bearing; the rotor is wound around an inner sidewall of the rotor housing; and the rotor at least partially surrounds and faces the stator.

9. The patch-type rotating mirror according to claim 1, wherein the mirror lens is provided in plurality, the plurality of mirror lenses are arranged circumferentially around a sidewall of the mounting structure, and any two adjacent mirror lenses abut each other.

10. A radar, comprising a patch-type rotating mirror, wherein the patch-type rotating mirror comprises: a mirror lens; a mounting structure, wherein the mirror lens is disposed on the mounting structure; a buffer structure, wherein the buffer structure is elastic, the buffer structure is disposed between the mirror lens and the mounting structure, one end of the buffer structure is connected to the mirror lens, and the other end of the buffer structure is connected to the mounting structure; and a drive assembly, wherein the mounting structure is drivingly connected to the drive assembly, the drive assembly is configured to drive the mounting structure to rotate, and the mirror lens rotates synchronously with the mounting structure.
